(19) United States
(12) Patent Application Publication
(10) Pub. No.: US 2018/0096142 A1
(43) Pub. Date: Apr. 5, 2018

(54) SYSTEM AND METHOD FOR DETERMINING A SECURITY CLASSIFICATION OF AN UNKNOWN APPLICATION

(71) Applicants: Huawei International Pte. Ltd., Singapore (SG); Singapore Management University, Singapore (SG)

(72) Inventors: Ke Xu, Singapore (SG); Yingjiu Li, Singapore (SG); Robert H. Deng, Singapore (SG)

(73) Assignees: Huawei International Pte. Ltd., Singapore (SG); Singapore Management University, Singapore (SG)

(21) Appl. No.: 15/833,663

(22) Filed: Dec. 6, 2017

Related U.S. Application Data
(63) Continuation of application No. PCT/SG2016/050145, filed on Mar. 28, 2016.

(30) Foreign Application Priority Data
Jun. 9, 2015 (SG) SG10201504543V

(51) Int. Cl. G06F 21/56; G06F 9/54; G06K 9/62; G06F 17/27

(52) U.S. Cl. CPC G06F 21/56; G06F 9/54; H04L 63/20; G06F 17/2705; G06K 9/6267

(57) ABSTRACT

This application describes a system and method for determining a security classification that is to be accorded to an unknown application using a trained classification model. The application describes a system and method for training the classification model so that the classification model may be subsequently used to determine whether an unknown application is to be classified as malicious and/or benign.

### CROSS-REFERENCE TO RELATED APPLICATIONS

This application is a continuation of International Application No. PCT/SG2016/050145, filed on Mar. 28, 2016, which claims priority to Singapore Patent Application No. SG10201504543V, filed on Jun. 9, 2015. The disclosures of the aforementioned applications are hereby incorporated by reference in their entireties.

### TECHNICAL FIELD APPLICATION

This application relates to a system and method for determining a security classification.

### BACKGROUND

Linux based operating systems, such as an Android operating system, are nowadays widely used in mobile devices, smartphones, tablet computers and portable computers. Applications developed for such operating systems are usually developed in Java and usually reside in the application layer of the operating system. Generally, each application in the operating system comprises four component types. The first component type is the activity component that defines an application's user interface, the second component type is the service component that performs background processing, the third component type is the content provider component that stores and shares data using relational database interfaces, and the fourth component type is the broadcast receiver component that acts as a mailbox for messages from other applications.

When a component wishes to communicate with another, the operating system will typically initiate an inter-component communication (“ICC”) process between these two components. It should also be noted that the inter-component communications are not limited to communications between components residing in a single application only and may also be used to facilitate the interaction between components in two different applications. To facilitate the ICC process, a message object, known as an Intent, is utilized. In general, there are two types of Intents, an explicit Intent and an implicit Intent.

An explicit Intent will specify a target's application package and class name. In particular, an explicit Intent contains a destination or an address of a target component. As such, data will be sent from the initiating component to the target component via the explicit Intent. As for an implicit Intent, an implicit Intent only specifies the Intent's action, category or data fields and leaves it to the operating system to determine which application or component is to receive this Intent. In order for a component to be able to receive implicit Intents, Intent Filters have to be specified for the component in the application's manifest or source file. In particular, an Intent Filter will describe the action, category or data fields of Intents that should be delivered by the operating system to the component.

Although Linux based operating systems are protected by Sandboxing and various Permission mechanisms, such operating systems are still vulnerable to various malware attacks such as code injection, return-oriented programming (ROP) and privilege escalation attacks. This is because users of the operating system are able to install various applications into their mobile devices, either from official sources or from unofficial sources. Once installed in a user's device, such malwares can exploit their own permissions to take advantage of other applications' privileged permissions to obtain and use sensitive data contained within the device. A common malware attack typically results in personal contacts and personal photos contained within the mobile device being stolen, and email and social media accounts being compromised. To mitigate the threat of such malwares, various approaches have since been proposed.

A solution that has been developed to address this problem involves installing a security service into the operating system to perform lightweight malware detection. This security service will evaluate the configuration of a new application before the application is allowed to be installed into the operating system. This is done by evaluating the configuration of the application against a collection of security rules. If the configuration of the application fails to pass this security check, the security service will prevent the application from being installed into the operating system. The downside of such a security service is that it is difficult to formulate and maintain an updated security rules database that is capable of detecting all types of malwares.

For the above reasons, those skilled in the art are constantly striving to come up with a system and method that is not dependent on security rule configurations, declared permission checking or sensitive application programming interface monitoring.

### SUMMARY APPLICATION

The above problem is solved and an advance in the art is made by systems and methods provided by embodiments in accordance with the application.

According to a first aspect of the application, a method for determining a security classification of an unknown application is provided, where the method comprises the steps of extracting inter-component communication sources and sinks from the unknown application, parsing the extracted inter-component communication sources and sinks to obtain inter-component communication related attributes, and values corresponding to each obtained inter-component communication related attribute, generating a behavioural pattern using the obtained inter-component communication related attributes, the values corresponding to each obtained inter-component communication related attribute and a pre-set attribute vector, and comparing the generated behavioural pattern of the unknown application with disruptive behaviour patterns contained in a classification model to determine the security classification of the unknown application.

With reference to the first aspect, in a first possible implementation manner of the first aspect, wherein the generating the behavioural pattern using the obtained inter-component communication related attributes, the values corresponding to each obtained inter-component communication related attribute and the pre-set attribute vector comprises the steps of building an application package vector for the unknown application using the obtained inter-component communication related attributes, the values corresponding to each obtained inter-component communication related attributes and the pre-set attribute vector, building an attribute-relation file using the application package vector built for the unknown application, and inputting the attribute-relation file built for the unknown application into the classification model to generate the behavioural pattern.

With reference to the first aspect or the first possible implementation manner of the first aspect, in a second possible implementation manner of the first aspect, wherein before the generating the behavioural pattern according to the obtained inter-component communication related attributes, the values corresponding to each obtained inter-component communication related attribute and the pre-set attribute vector, the method further comprises the step of processing known disruptive applications to obtain the pre-set attribute vector.

With reference to the second possible implementation manner of the first aspect, in a third possible implementation manner of the first aspect, wherein the processing known disruptive applications to obtain the pre-set attribute vector comprises the steps of extracting inter-component communication sources and sinks from the known disruptive applications, parsing the extracted inter-component communication sources and sinks from the known disruptive applications to obtain inter-component communication related attributes and values corresponding to each obtained inter-component communication related attribute, and removing duplicates and alphabetically arranging all the obtained inter-component communication related attributes to obtain the pre-set attribute vector.

With reference to the first aspect, or any one of the first to third possible implementation manners of the first aspect, in a fourth possible implementation manner of the first aspect, wherein before comparing the generated behavioural pattern of the unknown application with disruptive behaviour patterns contained in a classification model to determine a classification of the unknown application, the method further comprises the step of generating the classification model.

With reference to the fourth possible implementation manner of the first aspect, in a fifth possible implementation manner of the first aspect, wherein the generating the classification model comprises the steps of extracting inter-component communication sources and sinks from known disruptive applications, parsing the extracted inter-component communication sources and sinks from the known disruptive applications to obtain inter-component communication related attributes and values corresponding to each obtained inter-component communication related attribute, building an application package vector for each known disruptive application using the attribute vector, the inter-component communication related attributes and the values corresponding to the obtained inter-component communication related attributes as obtained from the known disruptive applications, whereby each application package vector has elements that each correspond to an attribute in the attribute vector, building a training attribute-relation file using all the application package vectors built for each of the known disruptive applications, and inputting the training attribute-relation file into the classification model.

With reference to the fifth possible implementation manner of the first aspect, in a sixth possible implementation manner of the first aspect, wherein the building the application package vector for each of the known disruptive applications using the attribute vector, the obtained inter-component communication related attributes and the values corresponding to the obtained inter-component communication related attributes comprises selecting an application from the known disruptive applications, generating a new application package vector for the selected application, initializing the elements in the application package vector using corresponding values of obtained inter-component communication related attributes for the application, wherein for each attribute in the application that does not have a corresponding value, the corresponding element in the application package vector is populated with a zero value, and repeating the above steps until all applications from the known disruptive applications have been selected.

With reference to the fifth possible implementation manner of the first aspect or the sixth possible implementation manner of the first aspect, in a seventh possible implementation manner of the first aspect, wherein the building the training attribute-relation file using the application package vectors built for each of the known disruptive applications comprises the steps of selecting a built application package vector from the application package vectors built for each of the known disruptive applications, choosing all elements in the selected built application package vector that have corresponding non-zero values, wherein for each chosen element, appending a sequence number of the element in front of the non-zero value of the element, populating the training attribute-relation file with all the appended non-zero values, a total number of attributes in the attribute vector and a label of an application associated with the application package vector, and repeating all the above steps until all built application package vectors of the known disruptive applications have been selected.

With reference to the third to seventh possible implementation manners of the first aspect, in an eighth possible implementation manner of the first aspect, wherein the parsing the extracted inter-component communication sources and sinks from the known disruptive applications to obtain inter-component communication related attributes, and the values corresponding to each obtained inter-component communication related attribute comprises the steps of retrieving application components of each known disruptive application from the extracted inter-component communication sources and sinks, and defining an application component attribute for each application component, wherein each application component attribute is accorded a corresponding value of one.

With reference to any one of the third to eighth possible implementation manners of the first aspect, in a ninth possible implementation manner of the first aspect, wherein the parsing the extracted inter-component communication sources and sinks from the known disruptive applications to obtain inter-component communication related attributes, and the values corresponding to each obtained inter-component communication related attribute further comprises the step of retrieving intent filters, action strings associated with each of the retrieved intent filters, and locations of each of the retrieved intent filters in each of the known disruptive applications, from the extracted inter-component communication sources and sinks, wherein for each known disruptive application, the retrieved intent filters are grouped according to a combination of the action string and location, and an intent filter attribute is defined for each group, wherein each intent filter attribute includes a corresponding value that is a sum of all the intent filters in the group.

With reference to any one of the third to ninth possible implementation manners of the first aspect, in a tenth possible implementation manner of the first aspect, wherein the parsing the extracted inter-component communication sources and sinks from the known disruptive applications to obtain inter-component communication related attributes, and the values corresponding to each obtained inter-component communication related attribute further comprises the step of retrieving intent filters and locations of each of the retrieved intent filters in each of the known disruptive applications from the extracted inter-component communication sources and sinks, wherein for each known disruptive application, the retrieved intent filters are grouped according to their location, and an intent filter attribute is defined for each group, wherein each intent filter attribute includes a corresponding value that is a sum of all the intent filters in the group.

With reference to any one of the third to tenth possible implementation manners of the first aspect, in a eleventh possible implementation manner of the first aspect, wherein the parsing the extracted inter-component communication sources and sinks from the known disruptive applications to obtain inter-component communication related attributes, and the values corresponding to each obtained inter-component communication related attribute further comprises the step of obtaining explicit intents of each known disruptive application from the extracted inter-component communication sources and sinks, and defining an explicit intent attribute for each known disruptive application, wherein the explicit intent attribute includes a corresponding value that is a sum of all the obtained explicit intents for the known disruptive application.

With reference to any one of the third to eleventh possible implementation manners of the first aspect, in a twelfth possible implementation manner of the first aspect, wherein the parsing the extracted inter-component communication sources and sinks from the known disruptive applications to obtain inter-component communication related attributes, and the values corresponding to each obtained inter-component communication related attribute further comprises the step of retrieving implicit intents from the extracted inter-component communication sources and sinks, wherein for each known disruptive application, the retrieved implicit intents are grouped according to a combination of an action string and a potential recipient, and an implicit intent attribute is defined for each group, wherein each implicit intent attribute includes a corresponding value that is a sum of all the implicit intents in the group.

With reference to any one of the first to twelfth possible implementation manners of the first aspect, in a thirteenth possible implementation manner of the first aspect, wherein the parsing the extracted inter-component communication sources and sinks from the known disruptive applications to obtain inter-component communication related attributes, and the values corresponding to each obtained inter-component communication related attribute further comprises the step of retrieving implicit intents from the extracted inter-component communication sources and sinks, wherein for each known disruptive application, the retrieved implicit intents are grouped according to a potential recipient, and an implicit intent attribute is defined for each group, wherein each implicit intent attribute includes a corresponding value that is a sum of all the implicit intents in the group.

According to a second aspect of the application, a system for determining a security classification of an unknown application is provided, where the system comprises a processing unit, and a non-transitory media readable by the processing unit, the media storing instructions that when executed by the processing unit, cause the processing unit to, extract inter-component communication sources and sinks from the unknown application; parse the extracted inter-component communication sources and sinks to obtain inter-component communication related attributes, and values corresponding to each obtained inter-component communication related attribute; generate a behavioural pattern using the obtained inter-component communication related attributes, the values corresponding to each obtained inter-component communication related attribute and a pre-set attribute vector; and compare the generated behavioural pattern of the unknown application with disruptive behaviour patterns contained in a classification model to determine a classification of the unknown application.

With reference to the second aspect, in a first possible implementation manner of the second aspect, wherein the instructions to generate the behavioural pattern using the obtained inter-component communication related attributes, the values corresponding to each obtained inter-component communication related attribute and the pre-set attribute vector comprises instructions for directing the processing unit to build an application package vector for the unknown application using the obtained inter-component communication related attributes, the values of each of these inter-component communication related attributes and the pre-set attribute vector; build an attribute-relation file using the application package vector built for the unknown application; and input the attribute-relation file built for the unknown application into the classification model to generate a behavioural pattern.

With reference to the second aspect or the first possible implementation manner of the second aspect, in a second possible implementation manner of the second aspect, wherein before the instructions to generate the behavioural pattern according to the obtained inter-component communication related attributes, the values corresponding to each obtained inter-component communication related attribute and the pre-set attribute vector, the system further comprises instructions for directing the processing unit to process known disruptive applications to obtain the pre-set attribute vector.

With reference to the second possible implementation manner of the second aspect, in a third possible implementation manner of the second aspect, wherein the instructions to process known disruptive applications to obtain the pre-set attribute vector comprises instructions for directing the processing unit to extract inter-component communication sources and sinks from the known disruptive applications; parse the extracted inter-component communication sources and sinks from the known disruptive applications to obtain inter-component communication related attributes and values corresponding to each obtained inter-component communication related attribute; and remove duplicates and alphabetically arrange all the obtained inter-component communication related attributes.

With reference to the second aspect, or any one of the first to third possible implementation manners of the second aspect, in a fourth possible implementation manner of the second aspect, wherein before the instructions to compare the generated behavioural pattern of the unknown application with disruptive behaviour patterns contained in a classification model to determine a classification of the unknown application, the system further comprises instructions for directing the processing unit to generate the classification model.

With reference to the fourth possible implementation manner of the second aspect, in a fifth possible implementation manner of the second aspect, wherein the instructions to generate the classification model comprises instructions for directing the processing unit to extract inter-component communication sources and sinks from known disruptive applications; parse the extracted inter-component communication sources and sinks from the known disruptive applications to obtain inter-component communication related attributes and values corresponding to each obtained inter-component communication related attribute; build an application package vector for each known disruptive application using the attribute vector, the inter-component communication related attributes and the values corresponding to the obtained inter-component communication related attributes as obtained from the known disruptive applications, whereby each application package vector has elements that each correspond to an attribute in the attribute vector; build a training attribute-relation file using all the application package vectors built for each of the known disruptive applications; and input the training attribute-relation file into the classification model.

With reference to the fifth possible implementation manner of the second aspect, in a sixth possible implementation manner of the second aspect, wherein the instructions to build the application package vector for each of the known disruptive applications using the attribute vector, the obtained inter-component communication related attributes and the values corresponding to the obtained inter-component communication related attributes comprises instructions for directing the processing unit to select an application from the known disruptive applications; generate a new application package vector for the selected application; populate the elements in the application package vector using corresponding values of obtained inter-component communication related attributes for the application, wherein for each attribute in the application that does not have a corresponding value, the corresponding element in the application package vector is populated with a zero value; and to repeat the above steps until all applications from the known disruptive applications have been selected.

With reference to the second aspect or any one of the first to sixth possible implementation manners of the second aspect, in a seventh possible implementation manner of the second aspect, wherein the instructions to build the training attribute-relation file using the application package vectors built for each of the known disruptive applications comprises instructions for directing the processing unit to select a built application package vector from the application package vectors built for each of the known disruptive applications; choose all elements in the selected built application package vector that have corresponding non-zero values, wherein for each chosen element, appending a sequence number of the element in front of the non-zero value of the element; populate the training attribute-relation file with all the appended non-zero values, a total number of attributes in the attribute vector and a label of an application associated with the application package vector; and repeat all the steps above until all built application package vectors of the known disruptive applications have been selected.

With reference to any one of the third to seventh possible implementation manners of the second aspect, in an eighth possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to retrieve application components of each known disruptive application from the extracted inter-component communication sources and sinks, and define an application component attribute for each application component, wherein each application component attribute is accorded a corresponding value of one.

With reference to any one of the third to eighth possible implementation manners of the second aspect, in an ninth possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to retrieve intent filters, action strings associated with each of the retrieved intent filters, and locations of each of the retrieved intent filters in each of the known disruptive applications, from the extracted inter-component communication sources and sinks, wherein for each known disruptive application, the retrieved intent filters are grouped according to a combination of the action string and location, and an intent filter attribute is defined for each group, wherein each intent filter attribute includes a corresponding value that is a sum of all the intent filters in the group.

With reference to any one of the third to ninth possible implementation manners of the second aspect, in an tenth possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to retrieve intent filters and locations of each of the retrieved intent filters in each of the known disruptive applications from the extracted inter-component communication sources and sinks, wherein for each known disruptive application, the retrieved intent filters are grouped according to their location, and an intent filter attribute is defined for each group, wherein each intent filter attribute includes a corresponding value that is a sum of all the intent filters in the group.

With reference to any one of the third to tenth possible implementation manners of the second aspect, in an eleventh possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to obtain explicit intents of each known disruptive application from the extracted inter-component communication sources and sinks, and defining an explicit intent attribute for each known disruptive application, wherein the explicit intent attribute includes a corresponding value that is a sum of all the obtained explicit intents for the application.

With reference to any one of the third to eleventh possible implementation manners of the second aspect, in an twelfth possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to retrieve implicit intents from the extracted inter-component communication sources and sinks, wherein for each known disruptive application, the retrieved implicit intents are grouped according to a combination of an action string and a potential recipient, and an implicit intent attribute is defined for each group, wherein each implicit intent attribute includes a corresponding value that is a sum of all the implicit intents in the group.

With reference to any one of the third to twelfth possible implementation manners of the second aspect, in an thirteenth possible implementation manner of the second aspect, wherein the instructions to parse the extracted inter-component communication sources and sinks from the known disruptive applications to obtain inter-component communication related attributes, and the values corresponding to each obtained inter-component communication related attribute comprises instructions for directing the processing unit to retrieve implicit intents from the extracted inter-component communication sources and sinks, wherein for each known disruptive application, the retrieved implicit intents are grouped according to a potential recipient, and an implicit intent attribute is defined for each group, wherein each implicit intent attribute includes a corresponding value that is a sum of all the implicit intents in the group.

A first advantage of embodiments of systems and methods in accordance with the application is that disruptive applications are detected based on the inter-component communication values located among or within applications and not based on declared permissions or sensitive application programming interfaces. This results in an efficient and accurate method and system for detecting disruptive applications.

A second advantage of embodiments of systems and methods in accordance with the application is that unknown disruptive applications that reuse similar Components, Intents or Intent Filters in the source code will be effectively detected as the behavioural patterns of such applications would have been captured and used to prime or train a classification model.

A third advantage of embodiments of systems and methods in accordance with the application is that the system and method is able to achieve a much higher malware detection rate as compared to existing malware detection systems or methods.

### BRIEF DESCRIPTION OF THE DRAWINGS

The above advantages and features in accordance with this application are described in the following detailed description and are shown in the following drawings:

FIG. 1 illustrating a block diagram of a system for generating a training attribute relation file for training a classification model in accordance with an embodiment of the application;

FIG. 2 illustrating a block diagram of a system for determining a classification of an unknown application using a trained classification model in accordance with embodiments of the application;

FIG. 3 illustrating a flow diagram of a process for determining a classification of an unknown application in accordance with embodiments of the application;

FIG. 4 illustrating a flow diagram of a process for obtaining applications' application component attribute and its corresponding value in accordance with embodiments of the application;

FIG. 5 illustrating a flow diagram of a process for obtaining applications' intent filter attribute and its corresponding value in accordance with embodiments of the application;

FIG. 6 illustrating a flow diagram of a process for obtaining applications' explicit intent attribute and its corresponding value in accordance with embodiments of the application;

FIG. 7 illustrating a flow diagram of a process for obtaining applications' implicit intent attribute and its corresponding value in accordance with embodiments of the application;

FIG. 8 illustrating a flow diagram of a process for building an application package vector for each known application in accordance with embodiments of the application;

FIG. 9 illustrating a flow diagram of a process for building a training attribute-relation file in accordance with embodiments of the application;

FIG. 10 illustrating a flow diagram of a process for obtaining and using an attribute-relation file for an unknown application in accordance with embodiments of the application; and

FIG. 11 illustrating a block diagram representative of processing systems providing embodiments in accordance with embodiments of the application.

### DETAILED DESCRIPTION

This application relates to a system and method for determining a security classification that is to be accorded to an unknown application using a trained classification model. More particularly, this application relates to a system and method for training the classification model so that the trained or primed classification model may be subsequently used to determine whether an unknown application is to be classified as malicious and/or benign.

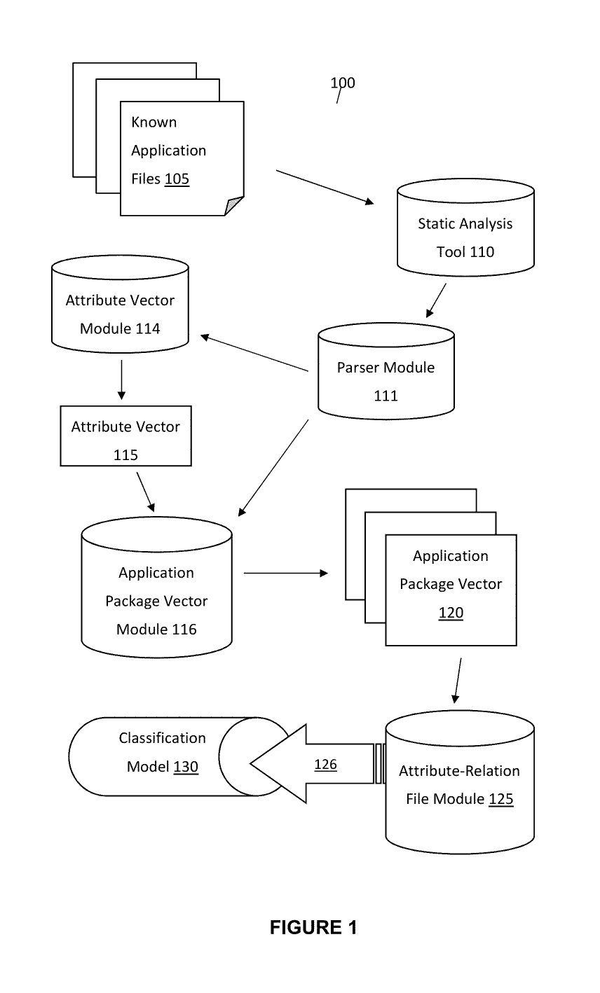

FIG. 1 illustrates training system 100 that includes modules that execute processes to provide a method and system for training or priming a classification model in accordance with embodiments of the application. These modules may be installed within mobile devices, smartphones, tablet computers, portable computers and/or such computer systems, and data or information may be transferred by these modules as required. The classification model may then subsequently be used to determine a classification of an unknown application.

System 100 operates in the follow manner. Known application files 105 are acquired and are fed into static analysis tool 110. Known application files 105 include, but are not limited to, malicious applications such as “Droid09”, “Android,Pjapps”, “Android.Geinimi”, “AndroidOS.FakePlayer”, or “com.wia.ucgepcdvlsl”, etc. and also include known benign applications that may typically be obtained from official sources. Malicious and/or benign applications may also be known as disruptive applications. One skilled in the art will recognize that any number of such disruptive applications may be utilized as known application files 105 or as the input of static analysis tool 110 without departing from this application.

Static analysis tool 110 is a module that receives an application file as an input and analyses the contents of the application file to obtain all the possible Intent senders, receivers, and contents of Intents that are included in the application. In particular, for each application that static analysis tool 110 receives; static analysis tool 110 outputs inter-component communication (“ICC”) sources and sinks belonging to the application. These ICC sources and sinks comprises a list of entry points for the application that may be called by components in the application or in other applications, and a list of exit points for the application where the application may send an Intent to another component so that possible targets may be accurately ascertained. For example, upon analysing an application, static analysis tool 110 will provide the location of Intent senders in the source code of the application, the number of intents generated by an Intent sender in the application, package names and class names included in the explicit Intents of the application, action strings and categories included in the implicit Intents of the application, Intent Filters of the application and various components of the application. The exact workings of static analysis tool 110 are not discussed in detail in this application as such tools are known to persons skilled in the art. In embodiments of the application, an existing public static analysis tool known as EPICC may be utilized as static analysis tool 110 to provide the sources and sinks of applications.

All the inter-component communication (“ICC”) sources and sinks belonging to known application files 105, as provided by static analysis tool 110, are then directed to parser module 111. Parser module 111 then extracts ICC-related attributes and their corresponding values for each application from these ICC sources and sinks to generate a dictionary. In particular, each element contained within this dictionary corresponds to an ICC-related attribute belonging to an application together with its corresponding value. The ICC-related attributes belonging to an application that may be parsed by parser module 111 may include, but are not limited to, application component attributes of the application, intent filter attributes of the application, an explicit intent attribute of the application and implicit intent attributes of the application.

In order to obtain application component attributes of an application, parser module 111 extracts all the application components declared by the application and defines for each of these extracted application components a related application component attribute. Each of these unique application component attributes is then allocated a corresponding value of one. For example, for an application that has two components such as “com.nom.lib.app.AppProfileActivity” and “com.nom.lib.service.YGBroadcastReceiver”, two different application component attributes will be created in the dictionary. In this example, these attributes are “com.nom.lib.app.AppProfileActivity” attribute having a corresponding value of 1 and “com.nom.lib.service.YGBroadcastReceiver” attribute having a corresponding value of 1. All the applications that have been processed by static analysis tool 110 will be processed by parser module 111 as set out above.

In accordance with embodiments of the application, for the generation of intent filter attributes of an application, parser module 111 retrieves from the ICC sources and sinks all the intent filters associated with the application together with each intent filter's associated action string and location. These retrieved intent filters are then grouped according to a combination of an intent filter's action string and location. For each group, parser module 111 will then define an intent filter attribute that is associated with the group. Each intent filter attribute will also be accorded a corresponding value that is the sum of the intent filters in the group.

After that, parser module 111 may ungroup all the formed groups and subsequently regroup all the retrieved intent filters according to their location. Alternatively, parser module 111 may retrieve from the ICC sources and sinks all the intent filters associated with the application together with each intent filter's associated location. These retrieved intent filters are then grouped according to their location. Regardless of either approach adopted, an intent filter attribute is then defined for each group and each attribute will then be accorded a corresponding value that is the sum of the intent filters in the group. These new intent filter attributes are then added to the dictionary as well.

For example, for an application that has five intent filters with different action strings in the source code of the application and two intent filters with different action strings in the manifest file, nine intent filter attributes will be created in the dictionary. The intent filter attribute for intent filters located in the source code will have a corresponding value of 5 while the intent filter attribute for intent filters located in the manifest file will have a corresponding value of 2. The remaining intent filter attributes for intent filters which are grouped by the combination of the intent filter's action string and location will each have a corresponding value of 1. All the applications that have been processed by static analysis tool 110 will be processed by parser module 111 as set out above.

In accordance with further embodiments of the application, for the generation of explicit intent attributes of an application, parser module 111 retrieves from the ICC sources and sinks all the explicit intents of the application. Parser module 111 then defines an explicit intent attribute for the application and subsequently sums all the retrieved explicit intents to generate a corresponding value of the explicit intent attribute. For example, if the application sends out sixteen explicit intents, this means that an explicit intent attribute will be created in the dictionary whereby the explicit intent attribute of the application will have a corresponding value of 16. All the applications that have been processed by static analysis tool 110 will be processed by parser module 111 as set out above.

In accordance with yet further embodiments of the application, in order to generate implicit intent attributes of an application, parser module 111 retrieves from the ICC sources and sinks all the implicit intents of the application together with each implicit intent's action string and potential recipient. All the retrieved implicit intents are then grouped according to a combination of the implicit intent's action string and potential recipient. Parser module 111 then defines an implicit intent attribute for each group. Each implicit intent attribute will then be accorded a corresponding value that is the sum of the implicit intents in the group. All these implicit intent attributes and their corresponding values are then added to the dictionary.

Once this is done, parser module 111 will ungroup all the formed groups and subsequently regroup all the retrieved implicit intents according to a potential recipient of the implicit intents. Alternatively, parser module 111 may retrieve from the ICC sources and sinks all the implicit intents associated with the application together with each implicit intent's potential recipient. These retrieved implicit intents are then grouped according to their potential recipient. Regardless of either approach adopted, an implicit intent attribute is then defined for each group and each attribute will then be accorded a corresponding value that is the sum of the implicit intents in the group. These new implicit intent attributes are then added to the dictionary as well.

For example, for an application that contains 29 implicit intents, 10 out of these 29 implicit intents may have the same action string, e.g. “Update_Player” and the potential recipient may be the application itself, 7 out of these 29 implicit intents may also have the same action string “Update_Player” and the potential recipient may be another application, 6 out of these 29 implicit intents have the same action string “User_Present” and the potential recipient may be the application itself, while the remainder of the implicit intents with the same action string “User_Present” may have another application as the potential recipient. In this example, this would mean that six implicit intent attributes would be generated. The first implicit intent attribute “Update_Player(send_to_itself)” having a corresponding value of 10, the second implicit intent attribute “Update_Player(send_to_other)” having a corresponding value of 7, the third implicit intent attribute “User_Present(send_to_itself)” having a corresponding value of 6, the fourth implicit intent attribute “User_Present(send_to_other)” having a corresponding value of 6, the fifth implicit intent attribute having a corresponding value of 16, and the sixth implicit intent attribute having a corresponding value of 13. All the applications that have been processed by static analysis tool 110 will be processed by parser module 111 as set out above.

As shown in FIG. 1, the obtained ICC-related attributes and their corresponding values are then passed to attribute vector module 114 and application package vector module 116. Attribute vector module 114 creates attribute vector 115 by collecting and combining all the ICC-related attributes contained in the dictionary that have been generated by parser module 111. During the consolidation process, attribute vector module 114 uniquifies the attributes by deleting repeated attributes, i.e. attributes having the same description, from the combined list and sorting the ICC-related attributes in alphabetical order. The resulting attribute vector 115 is effectively an alphabetical list of all the ICC-related attributes for all the applications of known application files 105. It should be noted that the corresponding value of each ICC-related attribute is not included in attribute vector 115 and that attribute vector 115 is purely a list of ICC-related attributes arranged alphabetically.

The generated attribute vector 115 is then passed to application package vector module 116. Application package vector module 116 uses attribute vector 115 and the obtained ICC-related attributes and corresponding values to generate an application package vector for each application of known application files 105 whereby each generated application package vector will have elements that each correspond to an attribute in attribute vector 115. This means that if attribute vector 115 has 29,932 attributes, each generated application package vector will have 29,932 elements. This also means that if there are 1,000 applications in known application files 105, there will be a total of 1,000 application package vectors in application package vector 120.

Application package vector module 116 does this by first selecting an application from known application files 105 and creating an application package vector for the selected application. As mentioned above, the created application package vector will have the same number of elements as that contained in attribute vector 115. Application package vector module 116 will then populate the elements in the created application package vector using corresponding values of ICC-related attributes as obtained from parser module 111. If an application does not have an attribute listed in attribute vector 115, the corresponding element in the application package vector will be accorded a zero value.

The following example which utilizes applications A and B is used to describe the processes described above. Table 1 below sets out the ICC-related attributes and their corresponding values for applications A and B after the ICC sources and sinks of these two applications have been parsed by parser module 111. Table 1 also sets out the attribute vector generated for these two applications. It may be noted that the attributes in attribute vector are arranged in alphabetical order and that attribute vector does not contain any corresponding values.

TABLE 1

| ICC-Related Attribute and | |
|---|---|
| Corresponding Value | Attribute Vector |
| OS.AppA.(Activity): 1 | OS.AppA.(Activity) |
| OS.AppA.(Service): 1 | OS.AppA.(Broadcast) |
| OS.AppA.(Broadcast): 1 | OS.AppA.(Content) |
| OS.AppA.(Content): 1 | OS.AppA.(ExplicitIntent) |
| OS.AppA.(ExplicitIntent): 7 | OS.AppA.(ImplicitIntent) |
| OS.AppA.(ImplicitIntent): 2 | OS.AppA.(IntentFilter) |
| OS.AppA.(IntentFilter): 20 | OS.AppA.(Service) |
| OS.AppB.(Activity): 1 | OS.AppB.(Activity) |
| OS.AppB.(Service): 1 | OS.AppB.(Broadcast) |
| OS.AppB.(Broadcast): 1 | OS.AppB.(Content) |
| OS.AppB.(Content): 1 | OS.AppB.(ExplicitIntent) |
| OS.AppB.(ExplicitIntent): 17 | OS.AppB.(ImplicitIntent) |
| OS.AppB.(ImplicitIntent): 8 | OS.AppB.(IntentFilter) |
| OS.AppB.(IntentFilter): 11 | OS.AppB.(Service) |

To create an application package vector for application A, application package vector module 116 first creates a new application package vector that contains elements that each correspond to an attribute in attribute vector. As the attribute vector in this example has 14 attributes, this means that the created application package vector will also have 14 elements. A newly created application package vector for application A is show in Table 2 below.

Application package vector module 116 will then populate the elements in the application package vector using the corresponding values of the ICC-related attributes for application A. The resulting application package vector for application A is shown in Table 3.

TABLE 2
New Application Package Vector
OS.AppA.(Activity)
OS.AppA.(Broadcast)
OS.AppA.(Content)
OS.AppA.(ExplicitIntent)
OS.AppA.(ImplicitIntent)
OS.AppA.(IntentFilter)
OS.AppA.(Service)
OS.AppB.(Activity)
OS.AppB.(Broadcast)
OS.AppB.(Content)
OS.AppB.(ExplicitIntent)
OS.AppB.(ImplicitIntent)
OS.AppB.(IntentFilter)
OS.AppB.(Service)

TABLE 3
Populated Application Package Vector

1
1
1
7
2
20
1
0
0
0
0
0
0
0

After application package vector module 116 has built application package vectors for all the applications of known application files 105, these application package vectors are stored as application package vector 120. Application package vector 120 is then passed to attribute-relation file module 125 to generate attribute-relation file 126. Attribute-relation file module 125 does this by selecting a first built application package vector from application package vector 120. Module 125 then selects all the elements within that have anon-zero value. For all the selected elements, module 125 then appends a sequence number of the element in front of the non-zero value of the element. All these appended non-zero values are then added into attribute-relation file 126 by module 125. For each application package vector processed by attribute-relation file module 125, a total number of attributes belonging to the attribute vector and the application's label (i.e. malware or benign) will then be added into attribute-relation file 126 by module 125. This process is then repeated until all the application package vectors in application package vector 120 have been processed by attribute-relation file module 125.

To illustrate this process, based on the example set out in Tables 1-3, the appended non-zero values that have been generated for the application package vector created for application A are set out in Table 4 below.

TABLE 4
{1 1, 2 1, 3 1, 4 7, 5 2, 6 20, 7 1, 14 0} - A is a malicious application
{1 1,2 1, 3 1, 4 7, 5 2, 6 20, 7 1, 14 1} - A is a benign application

As shown in Table 4, elements that have a zero value have been omitted and the sequence number of the element has been appended in front of the non-zero value of the element for elements with non-zero values.

After a complete attribute-relation file 126 has been generated, attribute-relation file 126 will then be passed to classification model 130 to train or prime classification model 130 so that the primed classification model may be used to determine the classification of unknown applications. In other words, attribute-relation file 126 is used as the training set of data to assist classification model 130 in generating a behavioural pattern. Classification model 130 may comprise of any existing classification model that is able generate a behavioural pattern based on a dataset that is provided to the classification model. In accordance with embodiments of the application, classification model 130 may utilize classification methods such as Naïve Bayes, Support Vector Machine, Decision Tree, Random Forest and Bayesian Network to generate a behavioural pattern based on attribute-relation file 126. Since attribute-relation file 126 includes examples of disruptive applications, with built-in algorithms, classification methods are able to learn patterns of both benign and malicious applications, and the differences between malicious patterns and benign patterns. The exact workings of classification model 130 are not discussed in detail in this application as such classification methods are known to persons skilled in the art.

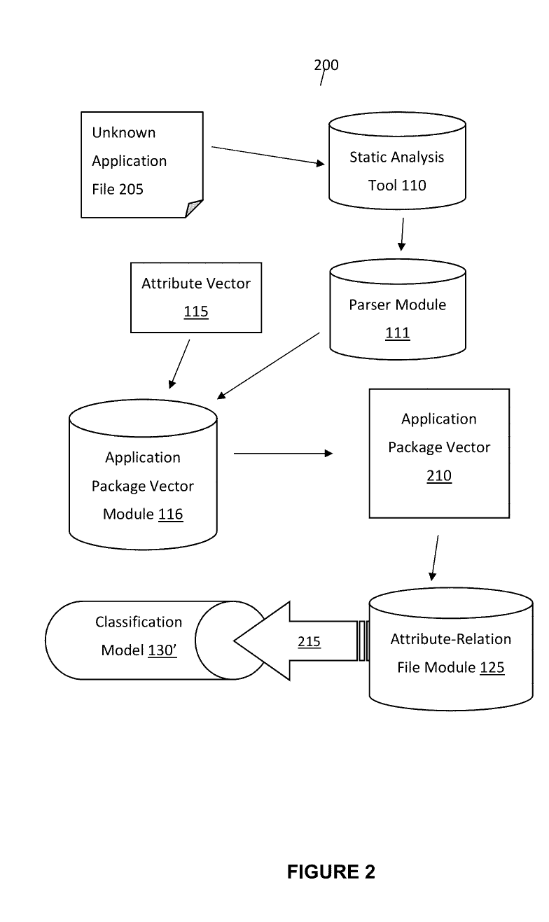

FIG. 2 illustrates detection system 200 that includes modules that execute processes to provide a method and system for using a primed classification model to determine a classification of an unknown application in accordance with embodiments of the application. Similarly, these modules may be installed within mobile devices, smartphones, tablet computers, portable computers and/or such computer systems, and data or information may be transferred by these modules as required.

System 200 operates in the following manner. Unknown application file 205 is first fed into static analysis tool 110. Static analysis tool 110 processes unknown application file 205 to obtain the ICC sources and sinks of unknown application file 205. The ICC sources and sinks which have been extracted from unknown application file 205 are then passed to parser module 111. Parser module 111 parses the ICC sources and sinks to obtain ICC-related attributes and their corresponding values associated with unknown application file 205.

Application package vector module 116 then uses the previously created attribute vector 115 and the ICC-related attributes and their corresponding values associated with unknown application file 205 to build application package vector 210.

Application package vector 210 is then provided to attribute-relation file module 125 which in turn processes application package vector 210 to produce attribute-relation file 215. Attribute-relation file 215 is then fed into primed classification model 130′. As described above, classification model 130′ is the classification model that was previously primed or trained by attribute-relation file 126. Primed classification model 130′ will receive attribute-relation file 215 and subsequently generate a behavioural pattern for unknown application file 205 based on the data in attribute-relation file 215. Primed classification model 130′ will then compare the pattern generated for unknown application file 205 with existing patterns of disruptive applications contained within. If primed classification model 130′ determines that the behavioural pattern of unknown application file 205 matches that of malicious applications, primed classification model will classify unknown application file 205 as a malicious or disruptive application. Conversely, if primed classification model 130′ determines that the behavioural pattern of unknown application file 205 matches that of benign applications, primed classification model will classify unknown application file 205 as a benign or disruptive application.

In accordance with an embodiment of the application, a method for determining a security classification of an unknown application is provided, whereby the method comprises the following four steps:
Step 1, extracting inter-component communication sources and sinks from the unknown application;
Step 2, parsing the extracted inter-component communication sources and sinks to obtain inter-component communication related attributes, and values corresponding to each obtained inter-component communication related attribute;
Step 3, generating a behavioural pattern using the obtained inter-component communication related attributes, the values corresponding to each obtained inter-component communication related attribute and a pre-set attribute vector; and
Step 4, comparing the generated behavioural pattern of the unknown application with disruptive behaviour patterns contained in a classification model to determine a classification of the unknown application.

Based on the previous example, in accordance with another example, step 3 further comprises the steps of building an application package vector for the unknown application using the obtained inter-component communication related attributes, the values corresponding to each obtained inter-component communication related attributes and the pre-set attribute vector; building an attribute-relation file using the application package vector built for the unknown application; and inputting the attribute-relation file built for the unknown application into the classification model to generate a behavioural pattern.

Based on the previous example, in accordance with another example, before generating the behavioural pattern according to the obtained inter-component communication related attributes, the values corresponding to each obtained inter-component communication related attribute and the pre-set attribute vector, the method further comprises the step of processing known disruptive applications to obtain the pre-set attribute vector.

Based on the previous example, in accordance with another example, the processing of known disruptive applications to obtain the pre-set attribute vector comprises the steps of extracting inter-component communication sources and sinks from the known disruptive applications; parsing the extracted inter-component communication sources and sinks from the known disruptive applications to obtain inter-component communication related attributes and values corresponding to each obtained inter-component communication related attribute; and removing duplicates and alphabetically arranging all the obtained inter-component communication related attributes.

Based on the previous example, in accordance with another example, before comparing the generated behavioural pattern of the unknown application with disruptive behaviour patterns contained in a classification model to determine a classification of the unknown application, the method further comprises the step of generating the classification model.

Based on the previous example, in accordance with another example, the generating the classification model comprises the steps of extracting inter-component communication sources and sinks from known disruptive applications; parsing the extracted inter-component communication sources and sinks from the known disruptive applications to obtain inter-component communication related attributes and values corresponding to each obtained inter-component communication related attribute; building an application package vector for each known disruptive application using the attribute vector, the inter-component communication related attributes and the values corresponding to the obtained inter-component communication related attributes as obtained from the known disruptive applications, whereby each application package vector has elements that each correspond to an attribute in the attribute vector; building a training attribute-relation file using all the application package vectors built for each of the known disruptive applications; and inputting the training attribute-relation file into the classification model.

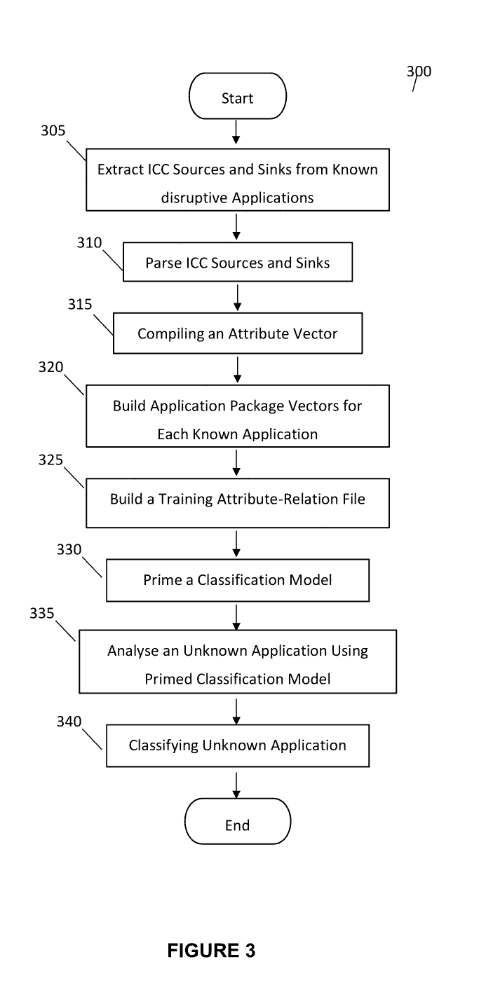

In order to provide such a system or method, a process is needed for generating a training dataset for priming or training a classification model so that the primed classification model may subsequently be used to determine the classification of an unknown application. A process is also needed for generating a dataset associated with the unknown application file whereby the dataset is to be used by the primed classification model for classifying the unknown application file. The following description and FIGS. 3-10 describe embodiments of processes that provide processes in accordance with this application.

FIG. 3 illustrates process 300 that is performed by a computer system to determine a security classification of an unknown application in accordance with embodiments of this application. Process 300 begins in step 305 by extracting ICC sources and sinks of known disruptive (i.e. malicious and/or benign) applications. The extracted ICC sources and sinks are then parsed at step 310 to obtain the ICC-related attributes and their corresponding values of all the known disruptive applications. Process 300 then compiles an attribute vector that contains all the ICC-related attributes that were obtained in step 310. The compiling of the attribute vector occurs at step 315. At step 320, process 300 utilizes the data in the attribute vector and the ICC-related attributes and their corresponding values to build application package vectors for each of the known disruptive applications. All the built application package vectors are then utilized by process 300 at step 325 to build a training attribute-relation file that is then subsequently used at step 330 to prime a classification model. During the priming or training of the classification model, process 300 will use the dataset in the training attribute-relation file to generate behavioural models for disruptive applications. Process 300 will then analyse an attribute-relation file associated with the unknown application at step 335 using the primed classification model to identify whether the behavioural pattern of the unknown application matches with disruptive behavioural patterns. Process 300 will then determine the security classification that is to be accorded to the unknown application at step 340. Process 300 then ends.

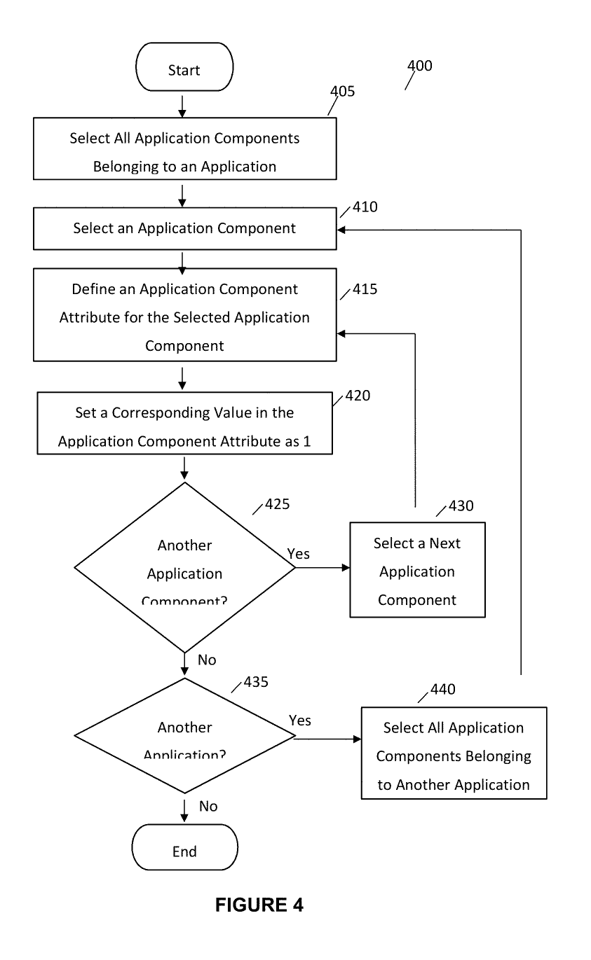

FIG. 4 illustrates process 400 that is performed by a computer system to parse the extracted ICC sources and sinks to obtain ICC related attributes and their corresponding values. Process 400 begins at step 405 by selecting all application components that belong to an application. At step 410, process 400 then selects an application component from the components selected in step 405. Process 400 then progresses to step 415 whereby an application component attribute is defined for the selected application component. At step 420, process 400 sets a corresponding value of the application component attribute defined in step 415 as 1. If there is another application component that has not yet been selected, process 400 progresses to step 430 else process 400 progresses to step 435. This decision making process occurs at step 425. At step 430, process 400 selects the next application component belonging to the application and progresses to step 415 whereby an application component attribute is defined for the selected application component. Process 400 repeats steps 415 to 425 until application component attributes have been defined for all the application components in the application. Process 400 then progresses to step 435. At step 435, process 400 determines whether there are application components belonging to other applications that may be selected. If process 400 determines that there are other application components belonging to another application that has yet to be selected by process 400, process 400 progresses to step 440 whereby all application components belonging to another application are selected. Process 400 then progresses to step 410 whereby an application component for the other application is selected and steps 410 to 435 repeats until application component attributes have been defined for all the application components belonging to all applications. Process 400 then ends.

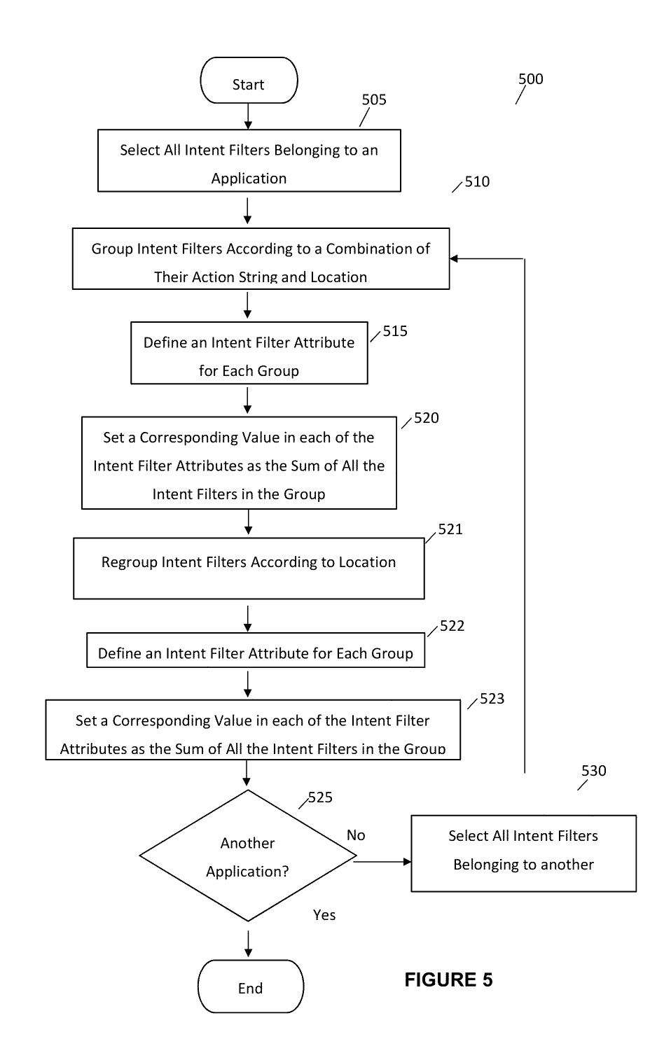

FIG. 5 illustrates process 500 that is performed by a computer system to parse the extracted ICC sources and sinks to obtain ICC related attributes and their corresponding values. Process 500 begins at step 505 by selecting all intent filters that belong to an application. The intent filters belonging to the application are then grouped according to a combination of their action string and location in step 510. Process 500 then defines an intent filter attribute for each formed group at step 515. At step 520, process 500 then sets a corresponding value of each group as the sum of all the intent filters contained in each group. At step 521, process 500 then regroups the intent filters belonging to the application according to their location. Process 500 then defines an intent filter attribute for each new formed group at step 522, and then sets a corresponding value of each group as the sum of all the intent filters contained in each group in step 523. Process 500 then determines at step 525 whether there are intent filters belonging to other applications that have yet to be selected. If process 500 determines that there are intent filters belonging to other applications that have not yet been selected, process 500 progresses to step 530. At step 530, process 500 selects all the intent filters that belong to another application. Process 500 then progresses to step 510 whereby all intent filters belonging to the other application are grouped according to their location. Process 500 repeats steps 510 to 525 until intent filter attributes have been defined for all intent filters belonging to all applications. Process 500 then ends.

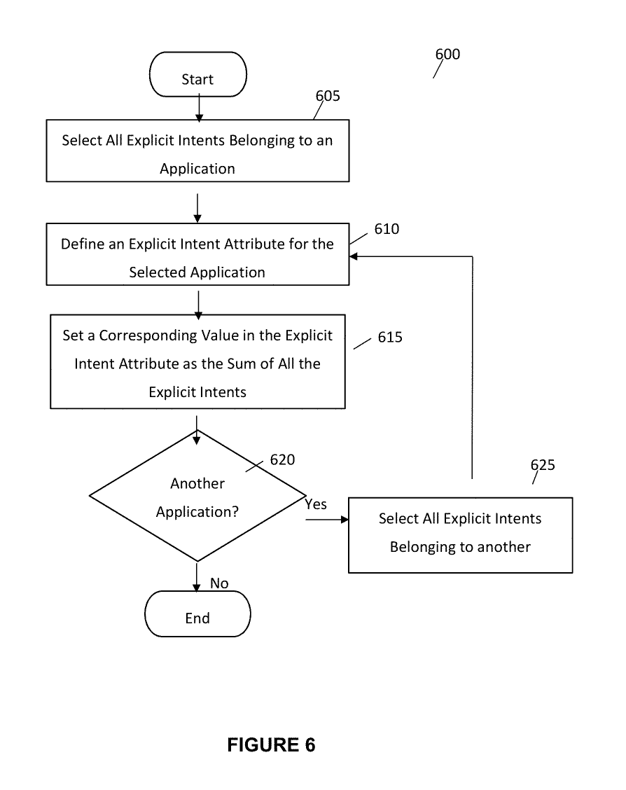

FIG. 6 illustrates process 600 that is performed by a computer system to parse the extracted ICC sources and sinks to obtain ICC related attributes and their corresponding values. Process 600 begins at step 605 by selecting all explicit intents that belong to an application.

An explicit intent attribute is then defined for the selected application at step 610. Process 600 then sets a corresponding value of the defined explicit intent attribute as the sum of all the explicit intents for the selected application at step 615. At step 620, process 600 determines whether there are explicit intents belonging to other applications that have yet to be selected. If explicit intents belonging to other applications have not yet been selected, process 600 progresses to step 625 whereby explicit intents for other applications are selected. Process 600 then progresses to step 610 whereby an explicit intent attribute is defined for the other application. Process 600 then repeats steps 610 to 620 until explicit intent attributes have been defined for all the applications. Process 600 then ends.

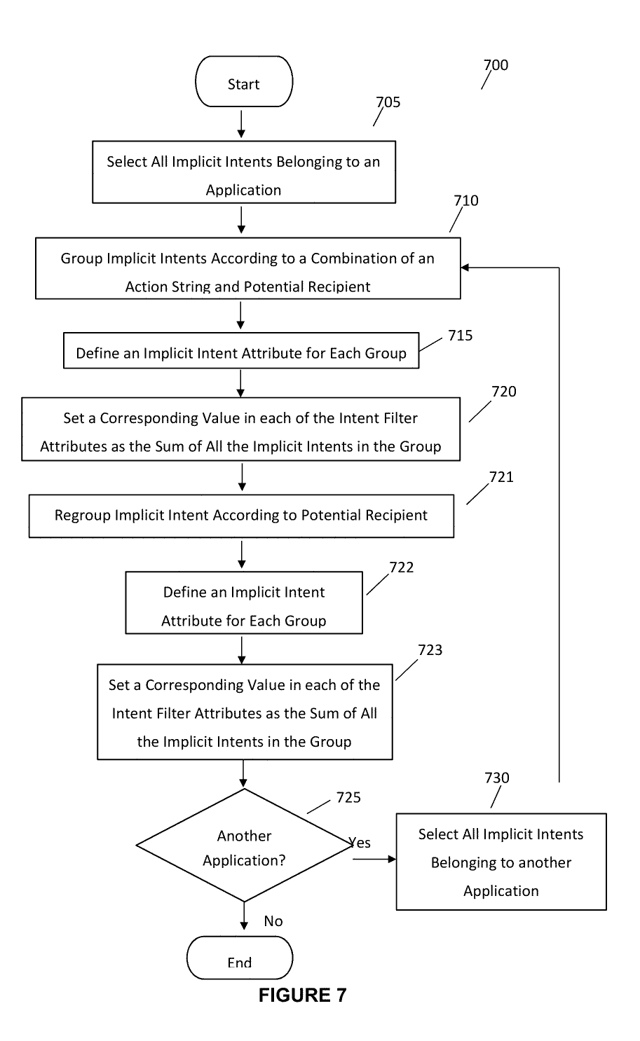

FIG. 7 illustrates process 700 that is performed by a computer system to parse the extracted ICC sources and sinks to obtain ICC related attributes and their corresponding values. Process 700 begins at step 705 by selecting all implicit intents belonging to an application. The implicit intents are then grouped according to a combination of an action string and potential recipient of the implicit intent at step 710. Process 700 then progresses to step 715 whereby an implicit intent attribute is defined for each group. At step 720, a corresponding value associated with each implicit intent attribute or each group is set as the sum of all the implicit intents contained within the group. At step 721, process 700 regroups the implicit intent belonging to the application according to their potential recipients. Process 700 then defines an implicit intent attribute for each new formed group at step 722, and then sets a corresponding value of each group as the sum of all the implicit intents contained in each group in step 723. Process 700 then determines at step 725 whether there are implicit intents belonging to other applications that have yet to be selected. If implicit intents belonging to other applications have not been selected, process 700 progresses to step 730. At step 730, implicit intents belonging to another application is selected. Process 700 then progresses to step 710 whereby implicit intents for the other selected application are grouped according to their common feature. Process 700 then repeats steps 710 to 725 until implicit intent attributes have been defined for all the applications. Process 700 then ends.

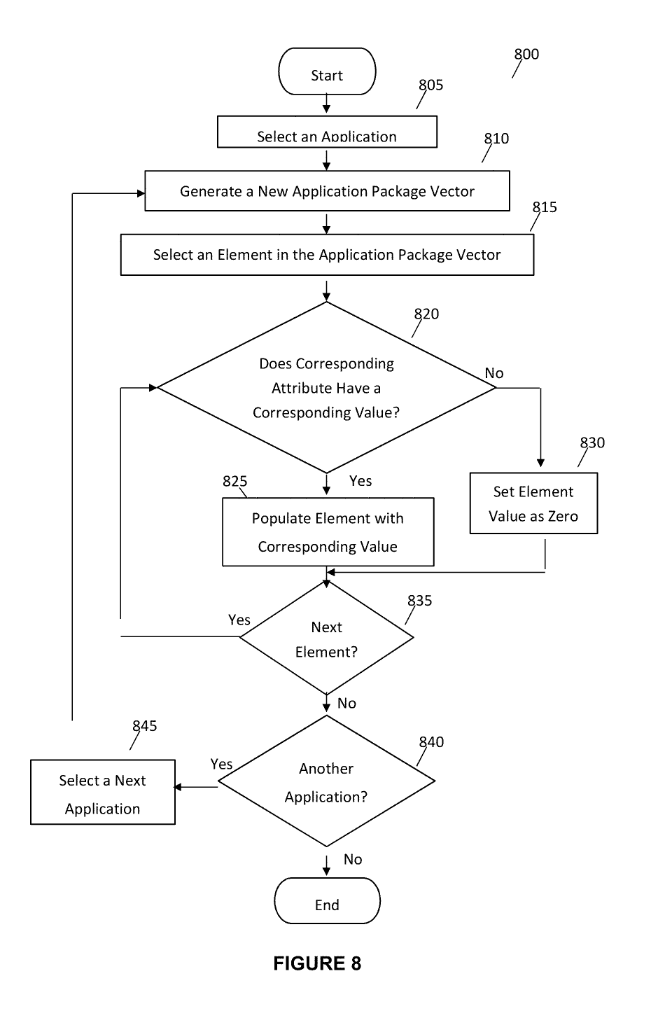

FIG. 8 illustrates process 800 that is performed by a computer system to build an application package vector for each of the known disruptive applications in accordance with embodiments of this application. Process 800 begins at step 805 by selecting an application. At step 810, process 800 generates a new application package vector for the selected application whereby each element in the application package vector corresponds to an attribute from the attribute vector. Process 800 then selects an element in the application package vector at step 815. At step 820, process 800 determines whether the selected element has a corresponding value. If the selected element does not have a corresponding value, process 800 progresses to step 830. At step 830, process 800 sets the selected element value as zero. Process 800 then progresses to step 835. Conversely, at step 820, if the selected element has a corresponding value, process 800 progresses to step 825. At step 825, process 800 populates the selected element with the corresponding value associated with that element. Process 800 then determines at step 835 whether there is another element to be selected in the application package vector. If process 800 determines that there is another element to be selected, process 800 then selects the other element and progresses to step 820. Process 800 repeats steps 820 to 835 until all the elements in the selected application package vector have been populated. Process 800 then progresses to step 840. At step 840, process 800 determines whether there is another application that has yet to be selected by process 800. If process determines that there is another application to be selected, process 800 progresses to step 845. At step 845, the next application is selected and process 800 progresses to step 810. At step 810, a new application package vector is generated for the application selected in step 845 and steps 810-840 repeats until application package vectors have been created for all the applications. Process 800 then ends.

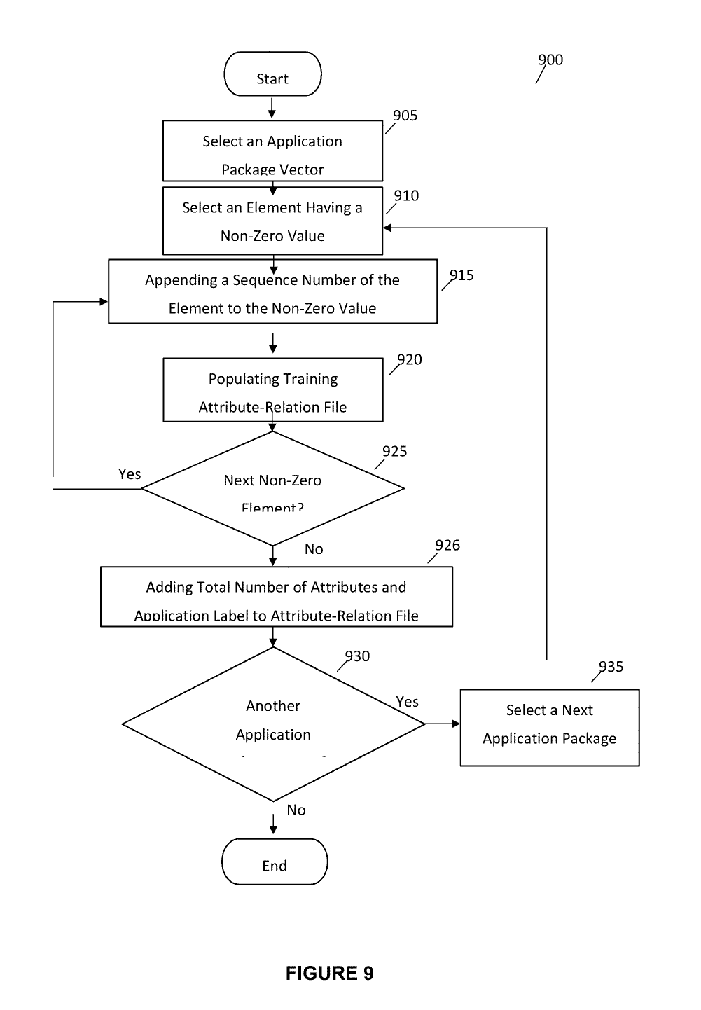

FIG. 9 illustrates process 900 that is performed by a computer system to build the training attribute-relation file in accordance with embodiments of this application. Process 900 begins at step 905 by selecting an application package vector. At step 910, process 900 then selects an element that has a non-zero value from a list of elements contained within the application package vector selected in step 905. Process 900 then appends a sequence number of the element in front of the non-zero value of the element at step 915. The non-zero value with the appended sequence number is then used to populate a training attribute-relation file. This occurs at step 920. Process 900 then determines at step 925 whether there is another element having a non-zero value in the selected application package vector. If there is another element that has a non-zero value, process 900 selects this element and then progresses to step 915. At step 915, a sequence number of the element is appended in front of the non-zero value of the element. Process 900 repeats steps 915 to 925 until all elements having non-zero values have been selected. Process 900 then progresses to step 930. At step 926, the total number of attributes belonging to the attribute vector and the application's label are added to training attribute-relation file. At step 930, process 900 determines whether there is another application package vector that has yet to be selected by process 900. If process 900 determines that there is another application package vector that has not yet been selected, process 900 will progress to step 935. At step 935, process 900 selects a next application package vector and then proceeds to step 910. An element having a non-zero value is then selected the list of elements contained within the application package vector selected in step 935. Process 900 then repeats step 910-930 until all application package vectors have been selected by process 900. Process 900 then ends.

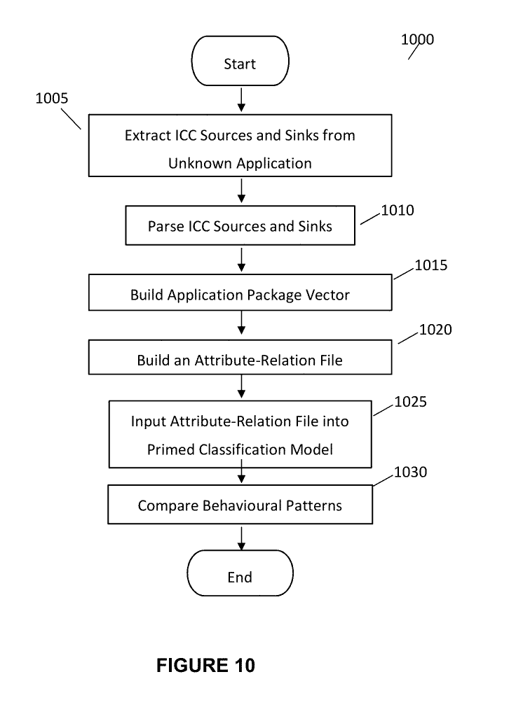

FIG. 10 illustrates process 1000 that is performed by a computer system to analyse an attribute-relation file associated with an unknown application in accordance with embodiments of this application. Process 1000 begins at step 1005 by extracting ICC sources and sinks from the unknown application. The extracted ICC sources and sinks are then parsed at step 1010. The resulting ICC-related attributes and corresponding values together with a previously generated attribute vector file are then used to build an application package vector for the unknown application at step 1015. At step 1020, process 1000 then builds an attribute-relation file for the unknown application using the application package vector generated in step 1015. Process 1000 then inputs the built attribute-relation file into the primed classification model at step 1025. The behavioural pattern of the unknown file is then compared to known behavioural patterns of disruptive applications at step 1030. Process 1000 then ends.

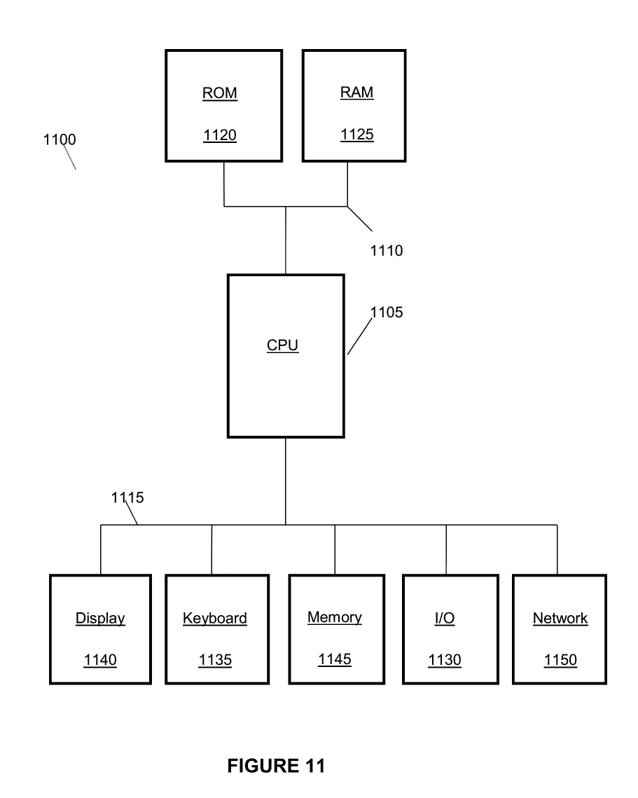

Processes provided by instructions stored in a non-transitory computer-readable media are executed by a processing unit in a computer system. For the avoidance of doubt, non-transitory computer-readable media shall be taken to comprise all computer-readable media except for a transitory, propagating signal. A computer system may be provided in one or more mobile devices and/or computer servers to provide this application. The instructions may be stored as firmware, hardware, or software. FIG. 11 illustrates an example of such a processing system. Processing system 1100 may be the processing system in the mobile devices and/or servers that execute the instructions to perform the processes for providing a method and/or system in accordance with embodiments of this application. One skilled in the art will recognize that the exact configuration of each processing system may be different and the exact configuration of the processing system in each mobile device may vary and FIG. 11 is given by way of example only.

Processing system 1100 includes Central Processing Unit (CPU) 1105. CPU 1105 is a processor, microprocessor, or any combination of processors and microprocessors that execute instructions to perform the processes in accordance with the present application. CPU 1105 connects to memory bus 1110 and Input/Output (I/O) bus 1115. Memory bus 1110 connects CPU 1205 to memories 1120 and 1125 to transmit data and instructions between memories 1120, 1125 and CPU 1105. I/O bus 1115 connects CPU 1105 to peripheral devices to transmit data between CPU 1105 and the peripheral devices. One skilled in the art will recognize that I/O bus 1115 and memory bus 1110 may be combined into one bus or subdivided into many other busses and the exact configuration is left to those skilled in the art.

A non-volatile memory 1120, such as a Read Only Memory (ROM), is connected to memory bus 1110. Non-volatile memory 1120 stores instructions and data needed to operate various sub-systems of processing system 1100 and to boot the system at start-up. One skilled in the art will recognize that any number of types of memory may be used to perform this function.

A volatile memory 1125, such as Random Access Memory (RAM), is also connected to memory bus 1110. Volatile memory 1125 stores the instructions and data needed by CPU 1105 to perform software instructions for processes such as the processes required for providing a system in accordance with embodiments of this application. One skilled in the art will recognize that any number of types of memory may be used as volatile memory and the exact type used is left as a design choice to those skilled in the art.

I/O device 1130, keyboard 1135, display 1140, memory 1145, network device 1150 and any number of other peripheral devices connect to I/O bus 1115 to exchange data with CPU 1105 for use in applications being executed by CPU 1105. I/O device 1130 is any device that transmits and/or receives data from CPU 1105. Keyboard 1135 is a specific type of I/O that receives user input and transmits the input to CPU 1105. Display 1140 receives display data from CPU 1105 and display images on a screen for a user to see. Memory 1145 is a device that transmits and receives data to and from CPU 1105 for storing data to a media. Network device 1150 connects CPU 1105 to a network for transmission of data to and from other processing systems.

The above is a description of embodiments of a system and process in accordance with the present application as set forth in the following claims. It is envisioned that others may and will design alternatives that fall within the scope of the following claims.

What is claimed is:

1. A method for determining a security classification of an unknown application, the method comprising:
extracting inter-component communication sources and sinks from the unknown application;
parsing the extracted inter-component communication sources and sinks to obtain inter-component communication related attributes, and values corresponding to each obtained inter-component communication related attribute;
generating a behavioural pattern using the obtained inter-component communication related attributes, the values corresponding to each obtained inter-component communication related attribute and a pre-set attribute vector; and
comparing the generated behavioural pattern of the unknown application with disruptive behaviour patterns contained in a classification model to determine the security classification of the unknown application.

2. The method according to claim 1 wherein the generating the behavioural pattern using the obtained inter-component communication related attributes, the values corresponding to each obtained inter-component communication related attribute and the pre-set attribute vector comprises:
building an application package vector for the unknown application using the obtained inter-component communication related attributes, the values corresponding to each obtained inter-component communication related attributes and the pre-set attribute vector;
building an attribute-relation file using the application package vector built for the unknown application; and
inputting the attribute-relation file built for the unknown application into the classification model to generate the behavioural pattern.

3. The method according to claim 1, wherein before the generating the behavioural pattern using the obtained inter-component communication related attributes, the values corresponding to each obtained inter-component communication related attribute and the pre-set attribute vector, the method further comprises:
processing known disruptive applications to obtain the pre-set attribute vector.

4. The method according to claim 3 wherein the processing known disruptive applications to obtain the pre-set attribute vector comprises:
extracting inter-component communication sources and sinks from the known disruptive applications;
parsing the extracted inter-component communication sources and sinks from the known disruptive applications to obtain inter-component communication related attributes and values corresponding to each obtained inter-component communication related attribute; and
removing duplicates and alphabetically arranging all the obtained inter-component communication related attributes to obtain the pre-set attribute vector.

5. The method according to claim 1, wherein before comparing the generated behavioural pattern of the unknown application with the disruptive behaviour patterns contained in the classification model to determine the security classification of the unknown application, the method further comprises:
generating the classification model.

6. The method according to claim 5 wherein the generating the classification model comprises:
extracting inter-component communication sources and sinks from known disruptive applications;
parsing the extracted inter-component communication sources and sinks from the known disruptive applications to obtain inter-component communication related attributes and values corresponding to each obtained inter-component communication related attribute;
building an application package vector for each known disruptive application using the pre-set attribute vector, the inter-component communication related attributes and the values corresponding to the obtained inter-component communication related attributes from the known disruptive applications, wherein the application package vector for each known disruptive application includes elements and each of the elements corresponds to an attribute in the pre-set attribute vector;
building a training attribute-relation file using each application package vector built for each of the known disruptive applications; and
inputting the training attribute-relation file into the classification model.

7. The method according to claim 6 wherein the building the application package vector for each of the known disruptive applications using the pre-set attribute vector, the inter-component communication related attributes and the values corresponding to the obtained inter-component communication related attributes from the known disruptive applications comprises:
a. selecting an application from the known disruptive applications;
b. generating a new application package vector for the selected application;
c. initializing the elements in the application package vector using corresponding values of obtained inter-component communication related attributes for the application, wherein for each attribute in the application that does not have a corresponding value, the corresponding element in the application package vector is populated with a zero value; and
d. repeating steps (a) to (c) until all applications from the known disruptive applications have been selected.

8. The method according to claim 6, wherein the building the training attribute-relation file using the application package vectors built for each of the known disruptive applications comprises:
a. selecting a built application package vector from the application package vectors built for each of the known disruptive applications;
b. choosing all elements in the selected built application package vector that have corresponding non-zero values, wherein for each chosen element, a sequence number of the element is appended in front of the non-zero value of the element;
c. populating the training attribute-relation file with all the appended non-zero values, a total number of attributes in the attribute vector and a label of an application associated with the application package vector; and
d. repeating steps (a) to (c) until all built application package vectors of the known disruptive applications have been selected.

9. The method according to claim 4 wherein the parsing the extracted inter-component communication sources and sinks from the known disruptive applications to obtain inter-component communication related attributes, and the values corresponding to each obtained inter-component communication related attribute comprises:
retrieving application components of each known disruptive application from the extracted inter-component communication sources and sinks; and
defining an application component attribute for each application component, wherein each application component attribute is accorded a corresponding value of one.

10. The method according to claim 4 wherein the parsing the extracted inter-component communication sources and sinks from the known disruptive applications to obtain inter-component communication related attributes, and the values corresponding to each obtained inter-component communication related attribute further comprises:
retrieving intent filters, action strings associated with each of the retrieved intent filters, and locations of each of the retrieved intent filters in each of the known disruptive applications, from the extracted inter-component communication sources and sinks, wherein for each known disruptive application, the retrieved intent filters are grouped according to a combination of the action string and location, and an intent filter attribute is defined for each group, and wherein each intent filter attribute includes a corresponding value that is a sum of all the intent filters in the group.

11. The method according to claim 4 wherein the parsing the extracted inter-component communication sources and sinks from the known disruptive applications to obtain inter-component communication related attributes, and the values corresponding to each obtained inter-component communication related attribute further comprises:
retrieving intent filters and locations of each of the retrieved intent filters in each of the known disruptive applications from the extracted inter-component communication sources and sinks, wherein for each known disruptive application, the retrieved intent filters are grouped according to their location, and an intent filter attribute is defined for each group, and wherein each intent filter attribute includes a corresponding value that is a sum of all the intent filters in the group.

12. The method according to claim 4, wherein the parsing the extracted inter-component communication sources and sinks from the known disruptive applications to obtain inter-component communication related attributes, and the values corresponding to each obtained inter-component communication related attribute further comprises:
obtaining explicit intents of each known disruptive application from the extracted inter-component communication sources and sinks; and
defining an explicit intent attribute for each known disruptive application, wherein the explicit intent attribute includes a corresponding value that is a sum of all the obtained explicit intents for the known disruptive application.

13. The method according to claim 4, wherein the parsing the extracted inter-component communication sources and sinks from the known disruptive applications to obtain inter-component communication related attributes, and the values corresponding to each obtained inter-component communication related attribute further comprises:
retrieving implicit intents from the extracted inter-component communication sources and sinks, wherein for each known disruptive application, the retrieved implicit intents are grouped according to a combination of an action string and a potential recipient, and an implicit intent attribute is defined for each group, and wherein each implicit intent attribute includes a corresponding value that is a sum of all the implicit intents in the group.

14. The method according to claim 4, wherein the parsing the extracted inter-component communication sources and sinks from the known disruptive applications to obtain inter-component communication related attributes, and the values corresponding to each obtained inter-component communication related attribute further comprises:
retrieving implicit intents from the extracted inter-component communication sources and sinks, wherein for each known disruptive application, the retrieved implicit intents are grouped according to a potential recipient, and an implicit intent attribute is defined for each group, and wherein each implicit intent attribute includes a corresponding value that is a sum of all the implicit intents in the group.

15. A system for determining a security classification of an unknown application, the system comprising:
a non-transitory memory storage comprising instructions; and
one or more processors in communication with the memory storage, wherein the one or more processors execute the instructions to:
extract inter-component communication sources and sinks from the unknown application;
parse the extracted inter-component communication sources and sinks to obtain inter-component communication related attributes, and values corresponding to each obtained inter-component communication related attribute;
generate a behavioural pattern using the obtained inter-component communication related attributes, the values corresponding to each obtained inter-component communication related attribute and a pre-set attribute vector; and
compare the generated behavioural pattern of the unknown application with disruptive behaviour patterns contained in a classification model to determine a classification of the unknown application.

16. The system according to claim 15 wherein the instructions to generate the behavioural pattern using the obtained inter-component communication related attributes, the values corresponding to each obtained inter-component communication related attribute and the pre-set attribute vector comprises:
instructions for directing the processing unit to:
build an application package vector for the unknown application using the obtained inter-component communication related attributes, the values of each of these inter-component communication related attributes and the pre-set attribute vector;
build an attribute-relation file using the application package vector built for the unknown application; and
input the attribute-relation file built for the unknown application into the classification model to generate a behavioural pattern.

17. The system according to claim 16, wherein before the instructions to generate the behavioural pattern according to the obtained inter-component communication related attributes, the values corresponding to each obtained inter-component communication related attribute and the pre-set attribute vector, the system further comprises:
instructions for directing the processing unit to:
process known disruptive applications to obtain the pre-set attribute vector.

18. The system according to claim 17 wherein the instructions to process known disruptive applications to obtain the pre-set attribute vector comprises:
instructions for directing the processing unit to:
extract inter-component communication sources and sinks from the known disruptive applications;
parse the extracted inter-component communication sources and sinks from the known disruptive applications to obtain inter-component communication related attributes and values corresponding to each obtained inter-component communication related attribute; and
remove duplicates and alphabetically arrange all the obtained inter-component communication related attributes to obtain the pre-set attribute vector.

19. The system according to claim 15, wherein before the instructions to compare the generated behavioural pattern of the unknown application with the disruptive behaviour patterns contained in a classification model to determine the security classification of the unknown application, the system further comprises:
instructions for directing the processing unit to:
generate the classification model.

20. The system according to claim 19 wherein the instructions to generate the classification model comprises:
instructions for directing the processing unit to:
extract inter-component communication sources and sinks from known disruptive applications;
parse the extracted inter-component communication sources and sinks from the known disruptive applications to obtain inter-component communication related attributes and values corresponding to each obtained inter-component communication related attribute;
build an application package vector for each known disruptive application using the pre-set attribute vector, the inter-component communication related attributes and the values corresponding to the obtained inter-component communication related attributes from the known disruptive applications, wherein the application package vector for each known disruptive application includes elements and each of the elements corresponds to an attribute in the pre-set attribute vector;
build a training attribute-relation file using each application package vectors built for each of the known disruptive applications; and
input the training attribute-relation file into the classification model.
